(19) United States
(12) Patent Application Publication
(10) Pub. No.: US 2002/0011679 A1
(43) Pub. Date: Jan. 31, 2002

(54) Carburetor with a starting device

(76) Inventor: Johannes Lugger, Hamburg (DE)

Correspondence Address: McCormick, Paulding & Huber LLP, CityPlace II, 185 Asylum Street, Hartford, CT, 06103-3402, US

(21) Appl. No.: 09/910,496

(22) Filed: Jul. 19, 2001

(30) Foreign Application Priority Data
Jul. 26, 2000 (DE) 200 12 919.8

(51) Int. Cl. F02M 1/00

(52) U.S. Cl. 261/38

(57) ABSTRACT

A choke valve of an engine carburetor is movable between “ON” and “OFF” end positions relative to the carburetor body and is biased to a selected one of the two positions by a spring which passes through a dead point during movement of the choke valve from one to the other of the end positions. A separate adjusting element movably mounted on the carburetor body and positionable by the engine operator moves the valve element past the dead point to achieve movement of the valve from one to the other of its end points without the adjusting element being drivingly connected with the choke valve in at least the “ON” end position of the valve.

### DESCRIPTION

For starting an internal combustion engine which is in a tool, a starting device is necessary in the carburetor, usually in form of a choke valve. The choke valve is characterized among other things in that it can take up at least two operating states, preferably the states “ON” and “OFF”. The change of the operating state can be caused by turning or pivoting the rotatably arranged choke valve about a defined angle, whereby both operating states are respectively at the beginning or at the end of the rotation angle area. The rotatable arrangement is usually guaranteed by a spindle fixedly connected with the choke valve which runs through a bore hole in the carburetor. An adjusting lever which is actively connected with an adjusting element to be actuated by the tool operator is also fixedly connected with the spindle. In order to guarantee a safe actuation, the adjusting element and the adjusting lever are usually connected with each other in at least one axis.

During the operation of such a tool, the carburetor and the housing surrounding it among other elements are excited to movements by vibrations. If a decoupling of the carburetor from the housing takes place due to appropriate damping elements, both components carry out different movements when excited. There results herefrom the problem of the assignment of the adjusting element to be actuated by the operator. If the adjusting element is assigned to the housing, the adjusting lever connected with the carburetor carries out, when excited, a movement with an amplitude and a frequency which differ from that of the adjusting element fixedly connected with it in at least one axis. Thus, the interface between the adjusting lever and the adjusting element is highly stressed during the operation of the tool and could fail.

An assignment of the adjusting element to the carburetor, i.e. to the adjusting lever, could remove this problem. However, when the operator actuates the adjusting element, the adjusting element itself and the carburetor assigned thereto is moved in its elastic damping elements used for the vibration decoupling. Thereby, additionally to the switching movement, the adjusting element carries out, when actuated, an undefined movement which is often felt by the operator as being unpleasant. Moreover, for an assignment of the adjusting element to the carburetor, the adjusting element itself and the housing carry out different movements by vibration excitation due to the operation of the tool. Since the adjusting element must be in any case guided through the housing, the leadthrough about the adjusting element must be selected so big as to exclude a damage of the differently vibrating parts. With this arrangement, a closed housing around the carburetor can hardly be realized because of certain requirements, for example in a motor saw.

Therefore, the aim of the invention is to create a choke actuation which does not show the described disadvantages and which in particular allows that the adjusting lever on the carburetor and the adjusting element to be actuated by the operator have no contact with each other during the operation of the tool and thus a damage of the adjusting lever or of the adjusting element is avoided in case of a different vibration excitation. Furthermore, it should be possible to assign the adjusting element to the housing surrounding the carburetor and to guide it through this housing almost without gap. In particular, for this assignment, when actuated the adjusting element should carry out only the actual switching movement.

The aim is achieved by the totality of the characteristic features of claim 1. The heart of the invention consists in configuring the adjusting lever of the choke spindle in such a way that, for a movement of the adjusting lever beyond a dead centre, the choke valve can compulsorily only take up the end positions “ON” and “OFF”.

A preferred configuration of the carburetor according to the invention is characterized in that the choke valve is placed on a spindle which is rotatably positioned in the carburetor body and which extends through the carburetor body to the outside, that the adjusting lever is fixed on the spindle, that a tension lever which extends transversaly to the spindle in a first direction is fixed on the spindle and that a tension spring is applied on the tension lever, this spring exerting a force directed opposite to the first direction. The dead centre results in this case when the axis of the spindle goes through a line which connects the working point of the tension spring and the fixing point of the other end of the tension spring with each other.

Preferably, for actuating the adjusting lever, a separate adjusting element is provided for which is in gear with the adjusting lever for pivoting the adjusting lever beyond the dead centre. In particular, the carburetor is placed in a housing, the adjusting element is guided through the housing to the outside and can be actuated from outside and the adjusting element is placed swivelling on the housing, the carburetor being arranged elastically in the housing and the adjusting lever and the adjusting element being disengaged when the adjusting lever takes up one of the two end positions.

The invention will be explained in detail below by means of an embodiment with reference to the attached drawings.

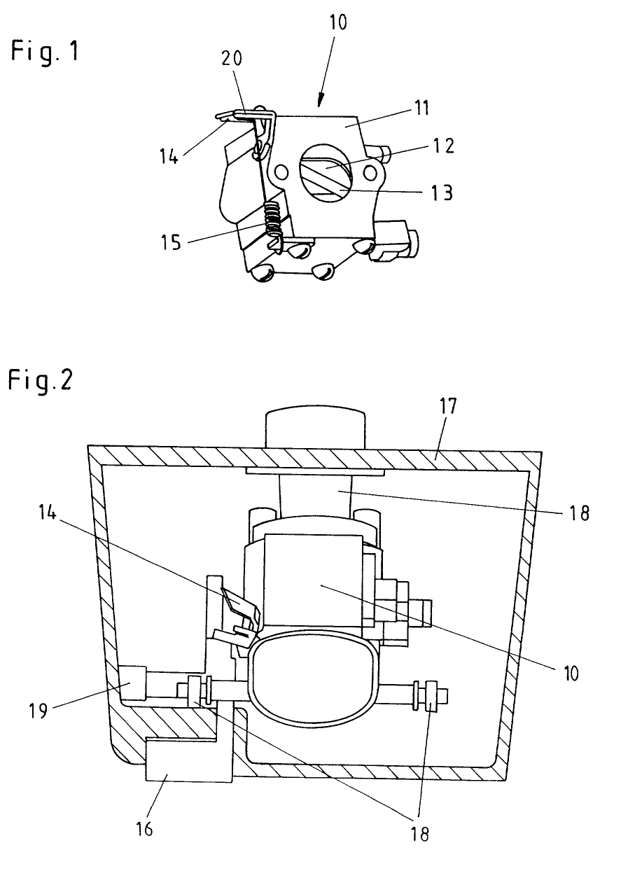

FIG. 1 is a perspective representation of a carburetor according to a preferred embodiment of the invention.

FIG. 2 shows the elastic suspension of the carburetor of FIG. 1 in a housing with an adjusting element fixed on the housing.

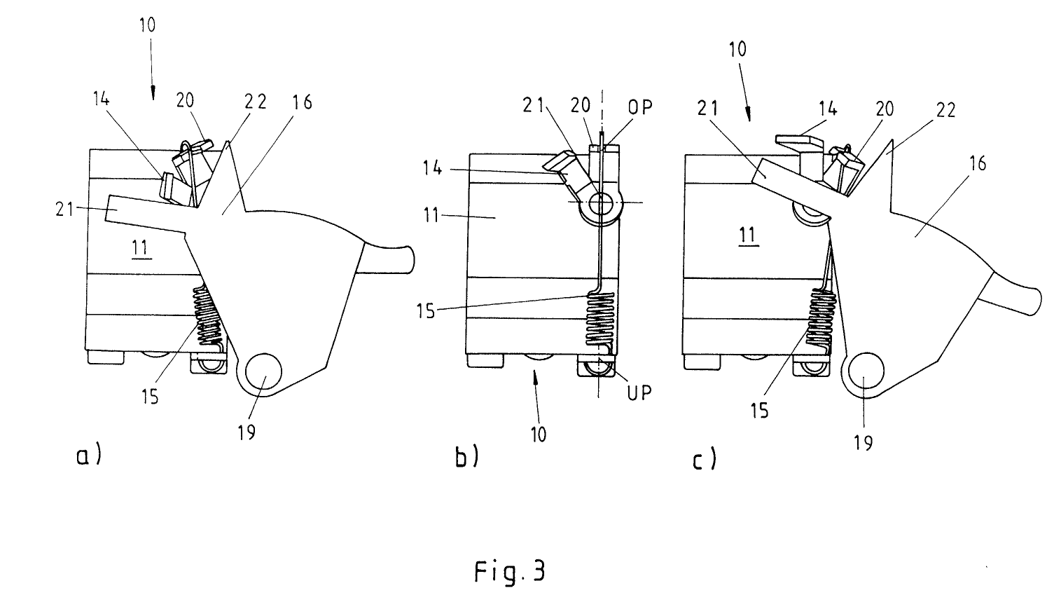

FIG. 3a-c are three partial figures which show both end positions (FIG. 3a and 3c) and the intermediary dead centre of the adjusting lever for the carburetor of FIG. 1.

FIG. 1 is a perspective representation of a carburetor according to a preferred embodiment of the invention. The carburetor 10 comprises a carburetor body 11 through which a conduit runs. In this conduit, a choke valve 12 is placed rotatably or swivelling on a spindle 13. The spindle 13 is positioned in a bore hole in the carburetor body 11 and extends at least one one side through the carburetor body 11 to the outside. Two levers connected with each other, namely an adjusting lever 14 and a tension lever 20, are fixed on the end of the spindle 13 which is situated outside the carburetor body 11—and for example formed out of a punched and bent sheet steel part. By swivelling the adjusting lever 14, the spindle 13 can be rotated and thus the choke valve 12 can be rotated and/or swivelled. The choke valve 12 preferably takes up two positions which are situated respectively at the end of the rotation angle area. In the one position, which is represented in FIG. 1, the choke valve 12 is in the “ON” position, i.e. it is approximately parallel to the axis of the intake duct. In the other position which is twisted about approximately 90°, the choke valve 12 is in the “OFF” position, i.e. it closes the duct. Corresponding end positions of the adjusting lever 14 are assigned to both positions of the choke valve 12.

According to the invention, there is now a dead centre between these two end positions of the adjusting lever 14, dead centre beyond which the adjusting lever 14 must be moved when it should be brought from the one end position to the other end position. Beyond the dead centre it moves automatically into the corresponding end position. According to FIG. 2, an adjusting element 16 is provided for actuating the adjusting lever 14. The adjusting element 16 is positioned swivellable by means of a drag bearing 10 in a housing 17 which surrounds the carburetor 10. The adjusting element 16 extends through the housing 17 and can be operated from outside. According to FIG. 3, it can be brought in gear with the adjusting lever 14 over two V-shaped widened actuating levers 21 and 22 in order to swivel the adjusting lever 14 into one of the two directions.

In the represented embodiment, the concrete embodiment of the dead centre consists in that a tension spring 15 is connected with the adjusting lever 14 as well as with the carburetor body 11 over the tension lever 20. If both suspension points OP and UP of the tension spring 15 on the tension lever 20 and on the carburetor body are in a line with the pivot of the adjusting lever 14 or of the choke spindle 13, this is the dead centre position (FIG. 3b). The distance between the two spring suspension points OP and UP is the biggest at this position and thus also the spring power. If the adjusting lever 14 is now moved further by a few degrees into one the two possible rotating directions, the distance of the spring suspension points OP and UP is reduced, the tension of the tension spring 15 is released and the adjusting lever 14 as well as the choke valve 12 connected herewith tilt into a defined operating state (“ON” according to FIG. 1 and/or 3c or “OFF” according to FIG. 3a). The movement of the adjusting lever 14 beyond the dead centre is obtained by the adjusting element 16 actuated by the tool operator. The adjusting lever 14 and the adjusting element 16 are constructed in such a way that they have contact with each other only when they are guided beyond the dead centre, while they are without any contact and/or disengaged in the two operating states “ON” and “OFF” of the choke valve 12. Thus, a relative movement of the two components to each other, caused by different vibration excitation during the operation of the tool, can be admitted.

Thus, an elastic suspension of the carburetor 10, its vibration being decoupled from the housing 17, is possible by means of corresponding elastic elements 18 (FIG. 2), while the adjusting element 16 to be operated by the operator can be assigned to the housing 17. For this assignment, the leadthrough of the adjusting element 16 through the housing 17 can be sealed. The adjusting element 16 carries out the switching movement alone when actuated since it is movably coordinated with the housing 17 in only one axis.

Because of the fact that the adjusting lever 14 must be guided beyond the dead centre and that it then automatically guides the choke valve 12 into one of its two operating positions by means of the spring tension of the tension spring 15, the whole system “actuation of a starting device” is not susceptible to tolerances. An elastic carburetor suspension as well as bigger tolerances for the fabrication of the adjusting lever 14 and of the adjusting element 16 are possible.

### LIST OF REFERENCE NUMERALS

10 Carburetor

11 Carburetor body

12 Choke valve

13 Spindle

14 Adjusting lever

15 Tension spring

16 Adjusting element

17 Housing

18 Elastic element

19 Drag bearing

20 Adjusting lever

21, 22 Actuating lever

OP Upper suspension point (tension spring)

UP Lower suspension point (tension spring)

1. A carburetor (10) with a starting device (12, . . . 16) which comprises a choke valve (12), which can swivel from a first closed position to a second open position, which is placed in a carburetor body (11) and which can swivel over an adjusting lever (14) fixed outside the carburetor body (11), characterized in that the adjusting lever (14) must be moved, when swivelling the choke valve (12), between the first and the second position beyond a dead centre and beyond the dead centre automatically takes up its end position assigned to the first or the second position.

2. A carburetor according to claim 1, characterized in that, for actuating the adjusting lever (14), a separate adjusting element (16) is provided for which is in gear with the adjusting lever (14) for swivelling the adjusting lever (14) beyond the dead centre and that the adjusting lever (14) and the adjusting element (16) are not in gear when the adjusting lever takes up one of the two end positions.

3. A carburetor according to claim 2, characterized in that the choke valve (12) is placed on a spindle (13) rotatably positioned in the carburetor body (11) and extending through the carburetor body (11) to the outside, that the adjusting lever (14) is fixed on the spindle (13), that a tension lever (20) extending transversely to the spindle (13) in a first direction is fixed on the spindle (13) and that a tension spring (15) which exerts a force directed opposite the first direction is applied on the tension lever (10).

4. A carburetor according to claim 3, characterized in that the tension spring (15) is fixed on the side of the spindle (13) on the carburetor body (11) which is opposite the tension lever (20).

5. A carburetor according to claim 4, characterized in that the carburetor (10) is placed in a housing (17), that the adjusting element (16) is guided through the housing (17) to the outside and can be actuated from outside and the adjusting element (16) is placed swivellable on the housing (17).
